(19) United States
(12) Patent Application Publication
(10) Pub. No.: US 2017/0050389 A1
(43) Pub. Date: Feb. 23, 2017

(54) 3D PRINTER

(71) Applicant: Byung-keuk Lee, Seoul (KR)

(72) Inventor: Byung-keuk Lee, Seoul (KR)

(21) Appl. No.: 15/343,528

(22) Filed: Nov. 4, 2016

Related U.S. Application Data
(63) Continuation of application No. PCT/KR2015/004567, filed on May 7, 2015.

(30) Foreign Application Priority Data
May 7, 2014 (KR) 10-2014-0054142

(51) Int. Cl. B29C 67/00; B33Y 40/00; B33Y 50/02; B33Y 30/00

(52) U.S. Cl. CPC B29C 67/0096; B29C 67/0062; B29C 67/0088; B33Y 30/00; B33Y 40/00; B33Y 50/02; B29K 2105/0058

(57) ABSTRACT

Disclosed is a 3D printer including a resin container which is filled with a photocurable liquid resin; a circulating pipe which forms a circulating channel through which the liquid resin is drained out of the resin container and then returned to the resin container; a circulating pump which circulates the liquid resin in the circulating channel; a heating unit which heats the liquid resin; and a filter which filters out impurities from the liquid resin in the circulating channel. According to the present invention, there is provided a 3D printer, in which cured floaters are easily removed by increasing fluidity of a liquid resin, a printed object is improved in quality, and the liquid resin is automatically replenished.

### REFERENCE TO RELATED APPLICATIONS

This application is a continuation of International Patent Application No. PCT/KR2015/004567, filed on May 7, 2015, which designates the United States and claims priority of Korean Patent Application No. 10-2014-0054142, filed on May 7, 2014, the entire contents of which are incorporated herein by reference.

### FIELD OF THE INVENTION

The present invention relates to a 3D printer.

### BACKGROUND OF THE INVENTION

A 3D printer of using a photocurable liquid resin builds a desired object by adding unit cured layers corresponding to respective cross-sections layer upon layer. Each of the unit cured layers is cured by image light emitted to the photocurable liquid resin.

Such a photocurable liquid resin is filled or stored in a resin tank, and varied in fluidity depending on temperature. Therefore, in seasons or environments where ambient temperature is low, the liquid resin may be not properly supplied to a building surface to thereby make printing quality deteriorate. Further, the liquid resin may be partially cured due to storage conditions, scattered light in a printing process, etc. and thus float in the liquid resin. By the way, such a floating impurity decreases the fluidity of the liquid resin, thereby lowering the printing quality.

As a curing reaction progresses, impurities increase and thus viscosity of the liquid resin changes. Like this, since the composition ratio of the liquid resin is changed, there is a need of replenishing the liquid resin. However, a conventional 3D printer is manually replenished with a liquid resin, and therefore has to be always monitored by a worker. In some cases, the liquid resin may be not replenished at an appropriate time, and a printed object may be defective.

### SUMMARY OF THE INVENTION

### Technical Problem

The present invention is conceived to solve the foregoing problems, and an aspect of the present invention is to provide a 3D printer which increases fluidity of a liquid resin and removes floating impurities, thereby improving quality of a printed object.

Another aspect of the present invention is to provide a 3D printer which is automatically replenished with a liquid resin.

### Technical Solution

In accordance with an embodiment of the present invention, a 3D printer includes: a resin container which is filled with a photocurable liquid resin; a circulating pipe which forms a circulating channel through which the liquid resin is drained out of the resin container and then returned to the resin container; a circulating pump which circulates the liquid resin in the circulating channel; a heating unit which heats the liquid resin; and a filter which filters out impurities from the liquid resin in the circulating channel.

The 3D printer may further comprise a temperature sensor which measures a temperature of the liquid resin; and a controller which controls the heating unit to heat the liquid resin if it is determined based on a temperature signal from the temperature sensor that the temperature of the liquid resin is lower than a predetermined lower limit temperature. Thus, it is possible to keep the temperature of the liquid resin higher than a predetermined temperature.

The heating unit may comprise a heating chamber for accommodating the liquid resin drained out of the resin container, a heater for heating the liquid resin in the heating chamber, and an agitator for stirring the liquid resin in the heating chamber. With this, it is possible to improve an effect of heating the liquid resin.

In accordance with an embodiment of the present invention, the 3D printer may further comprise: a replenishing tank which stores a replenishing liquid resin; a replenishing pipe which connects the liquid resin in the replenishing tank to the circulating pipe; and a selection valve which selects one of the replenishing liquid resin from the replenishing pipe and the liquid resin drained out of the resin container to be supplied to the resin container.

The 3D printer may further comprise: a level sensor which measures a level of the liquid resin in the resin container; and a controller which controls the selection valve and the circulating pump to replenish the resin container with the replenishing liquid resin in the replenishing tank if it is determined based on a level signal of the level sensor that the level of the liquid resin in the resin container is lower than a predetermined proper set level. Thus, the replenishing liquid resin in the replenishing tank is automatically supplied to the resin container in accordance with the level of the liquid resin in the resin container.

The selection valve may be provided upstream of the heating unit and the filter; the 3D printer may further comprise a bypass pipe which bypasses the heating unit and the filter; and the selection valve may select the liquid resin to be supplied to the resin container by bypassing the heating unit and the filter through the bypass pipe. Thus, it is possible to circulate the liquid resin or the replenishing liquid resin in more various methods.

### Advantageous Effects

According to the present invention, there is provided a 3D printer which increases fluidity of a liquid resin and removes floating impurities, thereby improving quality of a printed object.

Further, there is provided a 3D printer which is automatically replenished with a liquid resin.

### BRIEF DESCRIPTION OF THE DRAWINGS

FIG. 1 is a conceptual view of a 3D printer according to an embodiment of the present invention,

FIG. 2 is a conceptual view of a 3D printer according to another embodiment of the present invention,

FIG. 3 is a conceptual view of a 3D printer according to still another embodiment of the present invention,

FIG. 4 is a conceptual view of a 3D printer according to yet another embodiment of the present invention, and

FIG. 5 is a control block diagram of the 3D printer according to the present invention.

### DETAILED DESCRIPTION OF THE INVENTION

Below, embodiments of a 3D printer (100), (200), (300) according to the present invention will be described with reference to accompanying drawings.

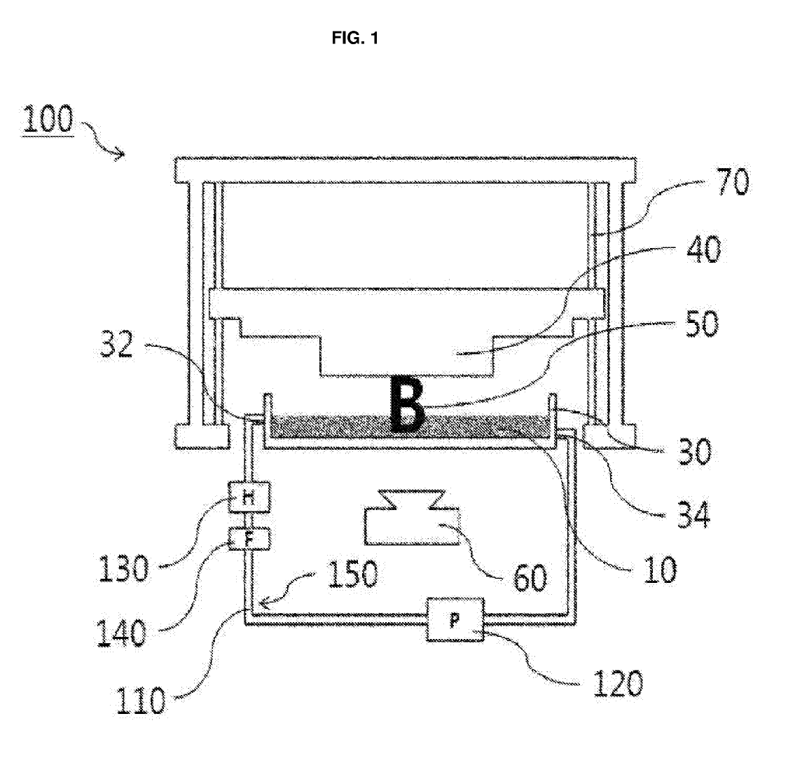

FIG. 1 is a conceptual view of a 3D printer (100) according to an embodiment of the present invention. As shown in FIG. 1, the 3D printer (100) includes a resin container (30) filled with a photocurable liquid resin (10), and an optical engine (60) placed below and spaced apart from the resin container (30). For convenience of description, it is illustrated that the optical engine (60) is placed below the resin container (30). Alternatively, the optical engine (60) may be placed above the resin container (30).

As shown in FIG. 1, the resin container (30) includes a bottom plate made of an approximately transparent material, and a building plate (40) for supporting a printed object (50) is arranged above the resin container (30). With this structure, image light is emitted from the optical engine (60) to the liquid resin (10) in the resin container (30) via the bottom plate of the resin container (30). The liquid resin (10) exposed to the image light is cured on the building plate (40). When one layer is completely cured, a building plate driver (70) drives the building plate (40) to move up and then stop while leaving a space for building the next cured layer. Then, image light for a corresponding cross-section is emitted for a curing process. As a process of moving up the building plate (40) and a curing process of emitting the image light are repeated, a 3D solid printed object (50) is completed.

The resin container (30) is provided with a circulating pipe (110). The circulating pipe (110) forms a circulating channel (150) through which the liquid resin (10) is drained, circulated and then returned to the resin container (30). Such circulation of the liquid resin (10) is achieved by an operation of a circulating pump (120) arranged on the circulating channel (150).

The circulating pipe (110) includes a first end connected to an outlet (32) through which the liquid resin (10) is drained out of the resin container (30), and a second end connected to an inlet (34) through which the circulated liquid resin (10) is returned to the resin container (30). In general, the outlet (32) is arranged at an upper portion of the resin container (30) so as to be level with the liquid resin (10), and the inlet (34) is arranged opposite to the outlet (32) at a lower portion of the resin container (30).

With this, floaters, which are substantially flowing on a surface of the liquid resin (10), are easily drained out of the resin container (30) via the outlet (32). Further, it is possible to minimize the fluidity of the liquid resin (10) in the resin container (30) even though the liquid resin (10) is circulated and then returned to the resin container (30), since the inlet (34) is placed at the lower portion of the resin container (30). The heights and positions of the outlet (32) and the inlet (34) may be properly selected in accordance with the structure of the resin container (30), the level of the liquid resin (10), etc. As necessary, a plurality of outlets and inlets may be provided at a plurality of positions in the resin container.

The circulating channel (150) is provided with a heating unit (130), and the heating unit (130) includes a heating chamber, a heater, and an agitator. The heating unit (130) makes the liquid resin (10) drained out of the resin container (30) be accommodated in the heating chamber and heated by the heater. Further, the liquid resin (10) is stirred by the agitator while being heated, and thus a heating efficiency increases.

With this, the heating unit (130) heats the liquid resin (10) circulating in the circulating channel (150), and thus lowers the viscosity of the liquid resin (10). In general, when the temperature of the liquid resin (10) is lower than a predetermined value, the fluidity is too low to circulate. Further, the liquid resin (10) is slowly spread out or biasedly supplied on a building surface during the curing process, thereby lowering the quality of the printed object (50).

Thus, the 3D printer (100) according to the preset invention employs the heating unit (130) to keep the temperature of the liquid resin (10) constant and thus increase the fluidity of the liquid resin (10), thereby making the liquid resin (10) smoothly circulate and improving the quality of the printed object (50). In this embodiment, the heating unit (130) is provided in the circulating channel (150), but not limited thereto. Alternatively, the heating unit may be provided in the resin container (30).

On the circulating channel (150), a filter (140) is arranged downstream of the heating unit (130). The filter (140) may be made of a filtering net, a filtering clot, etc. and include a single filtering material or a combination of plural filtering materials in accordance with various conditions such as the size of particle sizes to be filtered, the properties of the liquid resin (10), precision of a printed object, desired quality, etc. With this, the filter (140) removes cured or partially-cured floaters from the liquid resin (10). Thus, the liquid resin (10), which is heated by the heating unit (130) and of which impurities are filtered out through the filter (140), is returned to the resin container (30) by the circulating pump.

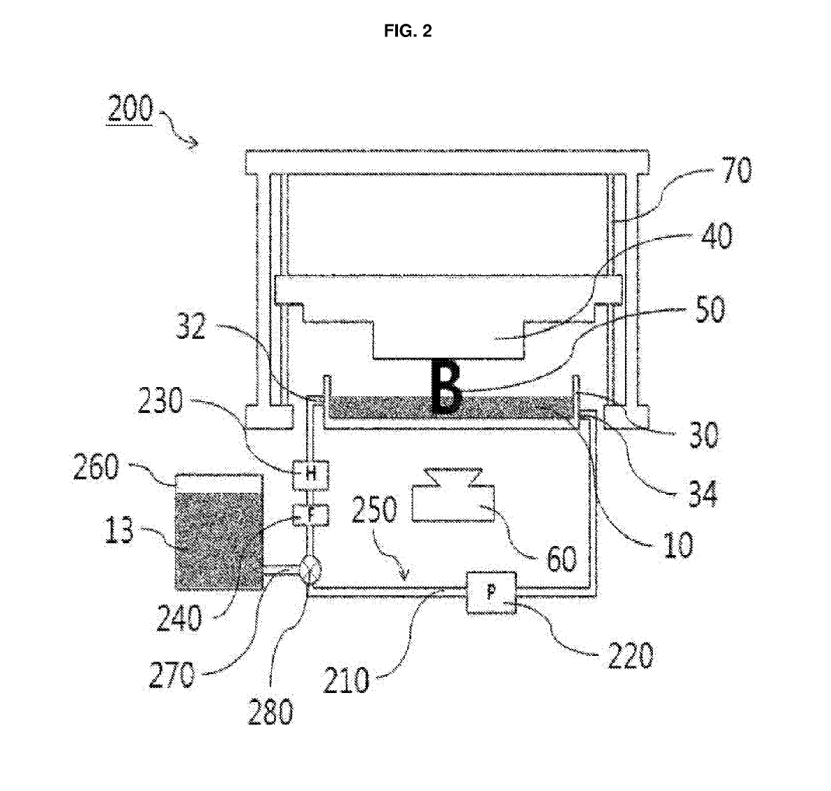

FIG. 2 is a conceptual view of a 3D printer (200) according to another embodiment of the present invention. The 3D printer (200) shown in FIG. 2 includes basically the same elements as that of FIG. 1, and further includes a replenishing tank (260) for supplying a replenishing liquid resin (13) to a circulating pipe (210).

As shown in FIG. 2, the replenishing tank (260) is arranged downstream of a heating unit (230) and a filter (240) and connected to the circulating pipe (210) via a replenishing pipe (270). The replenishing pipe (270) and the circulating pipe (210) may be connected by a three-way selection value (280), and thus the replenishing liquid resin (13) is selectively supplied through this selection valve (280) when needed.

In addition, the replenishing tank (260) may further include a pump for smoothly supply the replenishing liquid resin (13). This pump in the replenishing tank (260) may operate along with a circulating pump (220) so that the replenishing liquid resin (13) in the replenishing tank (260) can be smoothly supplied to the resin container (30). With this structure, the 3D printer (200) according to the present invention supplies the replenishing liquid resin (13) to the resin container (30) in accordance with the level of the liquid resin (10), thereby keeping the level of the liquid resin 10 constant in the resin container (30).

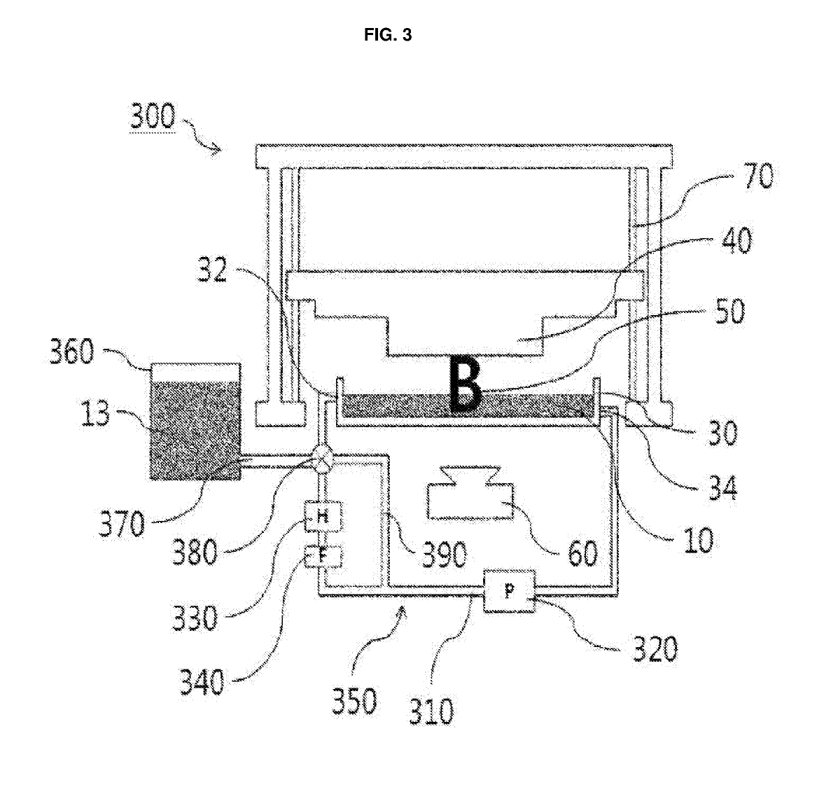

FIG. 3 is a conceptual view of a 3D printer (300) according to still another embodiment of the present invention. The 3D printer (300) shown in FIG. 3 includes basically the same elements as those of FIG. 1 and FIG. 2. However, a selection valve (380) is arranged upstream of a heating unit (330) and a filter (340), and a bypass pipe (390) is coupled to the selection valve (380) and bypasses the heating unit (330) and the filter (340). With this structure, the 3D printer (300) according to the present invention circulates the liquid resin (10) drained out of the resin container (30) after heating and filtering, or directly supplies the liquid resin (10) again to the resin container (30) via the bypass pipe (390) without heating and filtering.

Further, the replenishing liquid resin (13) in the replenishing tank (360) may be directly supplied to the resin container (30) via the bypass pipe (390), or may be supplied to the resin container (30) after heating and filtering. Like this, the position of the selection valve (380) is changed and the bypass pipe (390) is additionally provide, so that the liquid resin (10) can be variously circulated, thereby supplying the liquid resin (10) or the replenishing liquid resin (13) in various methods as necessary.

In the foregoing embodiments, a unit printed layer is cured as it is immersed in the liquid resin (10) of the resin container (30). In other words, the resin container (30) in these embodiments also serves as a building work space. Alternatively, the resin container (30) may be independently separated from the building work space.

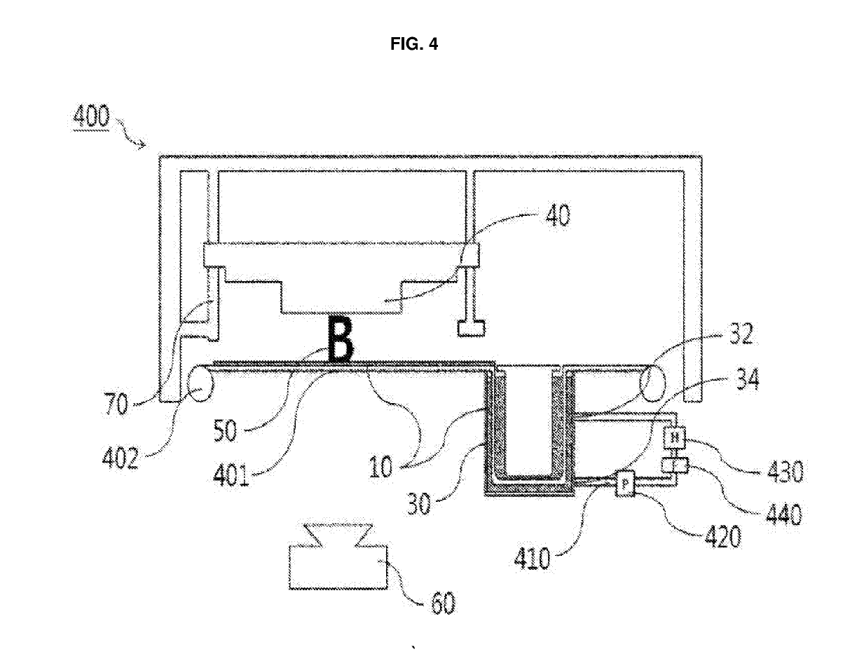

FIG. 4 is a conceptual view of a 3D printer (400) according to yet another embodiment of the present invention, in which the resin container (30) and the building work space are separated. As shown in FIG. 4, the 3D printer (400) includes the resin container (30) placed in a space separated from the optical engine (60) and the optical engine (60). The resin container (30) is filled with the photocurable liquid resin (10) to be supplied to the building work space, and the liquid resin (10) is supplied to the building work space through a supplying sheet (401). To supply the liquid resin (10) to the supplying sheet (401), a sheet driver (402) may be wound and unwound to move the supplying sheet (401) left and right, or the resin container (30) may directly move left and right.

If the sheet driver (402) is used to supply the liquid resin (10), a circulating pipe (410), a circulating pump (420), a heating unit (430) and a filter (440) are stationarily arranged as illustrated in FIGS. 1, 2 and 3. On the other hand, if the resin container (30) is moved to supply the liquid resin (10), these elements are movable or the circulating pipe (110) is flexible corresponding to the movement of the resin container (30). As necessary, the 3D printer (400) according to the present invention may further include the replenishing tank (260), (360), the replenishing pipe (270), (370), the selection valve (280), (380) and the bypass pipe (390).

In general, the circulation of the liquid resin (10) in the 3D printer is automatically controlled by a controller (500) even though it is manually controllable by a user.

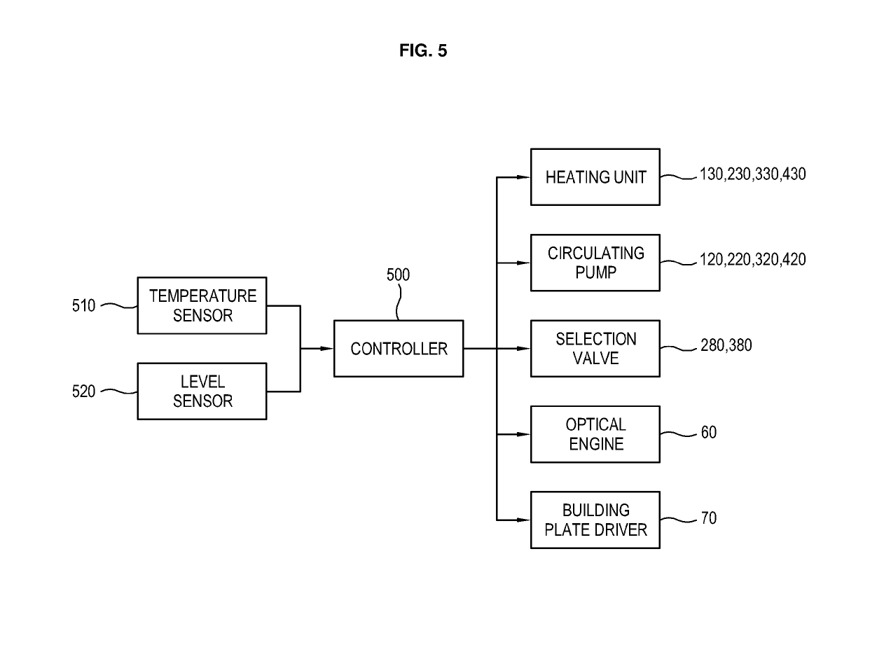

FIG. 5 is a control block diagram of the 3D printer (100), (200), (300), (400) according to the present invention. As shown in FIG. 5, the controller (500) receives signals about the temperature and level of the liquid resin (10) in the resin container (30) from a temperature sensor (510) and a level sensor (520). The temperature sensor (510) generally senses the temperature of the liquid resin (10) in the resin container (30), but may sense the temperature of the liquid resin (10) at a specific position on the circulating channel (150), (250), (350), (450) as necessary.

The controller (500) controls the heating unit (130), (230), (330), (430) based on a temperature signal received from the temperature sensor (510). For example, if it is determined that the received temperature signal indicates a temperature lower than a predetermined lower limit, the controller (500) controls the heating unit (130), (230), (330), (430) to heat the liquid resin (10). With this, the liquid resin (10) in the resin container (30) and the circulating channel (150), (250), (350), (450) is kept to have a temperature equal to or higher than the lower limit, thereby improving the fluidity of the liquid resin 10 in the resin container (30) and the circulating channel (150), (250), (350), (450).

Further, the controller (500) controls the resin container (30) to be replenished with the replenishing liquid resin (13) of the replenishing tank (260), (360) based on the level signal received through the level sensor (520). If it is determined based on the level signal about the liquid resin (10) in the resin container (30) that the level of the liquid resin (10) in the resin container (30) is lower than a predetermined proper level, the controller (500) controls the selection valves (280), (380) to supply the replenishing liquid resin (13) from the replenishing tank (260), (360) to the resin container (30). While the replenishing liquid resin (13) is supplied by the selection valve (280), (380), the liquid resin (10) is not drained out of the resin container (30). Thus, the resin container (30) is rapidly replenished with the replenishing liquid resin (13), so that the liquid resin (10) in the resin container (30) can be kept to have a level equal to or higher than the proper level.

As described above, the 3D printer according to the present invention includes the resin container (30) to be filled with the photocurable liquid resin (10); and the circulating pipe (110), (210), (310), (410) forming the circulating channel (150), (250), (350), (450) through which the liquid resin (10) drained out of the resin container (30) is circulated and then supplied again. The circulating channel (150), (250), (350), (450) includes the circulating pump (120), (220), (320), (420) for circulating the liquid resin (10); the heating unit (130), (230), (330), (430) for heating the liquid resin (10); and the filter (140), (240), (340), (440) for filtering out cured floaters. In addition, the replenishing tank (260), (360) is connected to one side of the circulating pipe (110), (210), (310), (410) through the replenishing pipe (270), (370), and selectively supplies the replenishing liquid resin (13) through the selection valve (280), (380). This circulation is controlled by the controller 500. The controller (500) controls the heating unit (130), (230), (330), (430), the selection valve (280), (380) and the circulating pump (120), (220), (320), (420) based on the signals about the temperature and level of the resin container (30), thereby keeping the temperature and level of the liquid resin (10) of the resin container (30) higher than a predetermined temperature and level.

The scope of the present invention is not limited to the illustrated embodiments, and is thus applicable to all the 3D printers as long as the liquid resin can be circulated therein.

What is claimed is:

1. A 3D printer comprising:
a resin container which is filled with a photocurable liquid resin;
a circulating pipe which forms a circulating channel through which the liquid resin is drained out of the resin container and then returned to the resin container;
a circulating pump which circulates the liquid resin in the circulating channel;
a heating unit which heats the liquid resin; and
a filter which filters out impurities from the liquid resin in the circulating channel.

2. The 3D printer according to claim 1, further comprising:
a temperature sensor which measures a temperature of the liquid resin; and
a controller which controls the heating unit to heat the liquid resin if it is determined based on a temperature signal from the temperature sensor that the temperature of the liquid resin is lower than a predetermined lower limit temperature.

3. The 3D printer according to claim 1, wherein the heating unit comprises a heating chamber for accommodating the liquid resin drained out of the resin container, a heater for heating the liquid resin in the heating chamber, and an agitator for stirring the liquid resin in the heating chamber.

4. The 3D printer according to claim 1, further comprising:
a replenishing tank which stores a replenishing liquid resin;
a replenishing pipe which connects the liquid resin in the replenishing tank to the circulating pipe; and
a selection valve which selects one of the replenishing liquid resin from the replenishing pipe and the liquid resin drained out of the resin container to be supplied to the resin container.

5. The 3D printer according to claim 4, further comprising:
a level sensor which measures a level of the liquid resin in the resin container; and
a controller which controls the selection valve and the circulating pump to replenish the resin container with the replenishing liquid resin in the replenishing tank if it is determined based on a level signal of the level sensor that the level of the liquid resin in the resin container is lower than a predetermined proper set level.

6. The 3D printer according to claim 4, wherein the selection valve is provided upstream of the heating unit and the filter;
the 3D printer further comprises a bypass pipe which bypasses the heating unit and the filter; and
the selection valve selects the liquid resin to be supplied to the resin container by bypassing the heating unit and the filter through the bypass pipe.
